(19) United States
(12) Patent Application Publication
(10) Pub. No.: US 2024/0338423 A1
(43) Pub. Date: Oct. 10, 2024

(54) CRYPTOGRAPHICALLY PROVING IDENTITY UNIQUENESS

(71) Applicant: Secure Identity, LLC, New York, NY (US)

(72) Inventor: Derek Gottfrid, New York, NY (US)

(21) Appl. No.: 18/591,284

(22) Filed: Feb. 29, 2024

Related U.S. Application Data
(60) Provisional application No. 63/457,110, filed on Apr. 4, 2023.

(51) Int. Cl. G06F 21/10; G06F 21/32

(52) U.S. Cl. CPC G06F 21/1014; G06F 21/32

(57) ABSTRACT

A system, apparatus, computer program product, and/or method cryptographically proves identity uniqueness. A verification request may be received. An identity associated with the verification request may be identified. The identity may be verified. In response to the verification request, an NFT may be generated. The NFT may be non-transferrable. The NFT may be stored on a blockchain. The NFT may be associated with a token wallet that is associated with the identity. The identity and/or aspects thereof may be verified by verifying that the token wallet that is associated with the identity is associated with the NFT.

### CROSS-REFERENCE TO RELATED APPLICATION(S)

This application is a nonprovisional patent application of and claims the benefit of U.S. Provisional Patent Application No. 63/457,110, filed Apr. 4, 2023 and titled “Cryptographically Proving Identity Uniqueness,” the disclosure of which is hereby incorporated herein by reference in its entirety.

### FIELD

The described embodiments relate generally to cryptographically proving identity uniqueness. More particularly, the present embodiments relate to cryptographically proving identity uniqueness using non-fungible tokens.

### BACKGROUND

There are many situations where a person or other entity may desire to verify a person's identity and/or aspects thereof. For example, a car rental agency might check a driver's license for a potential renter to verify that the person is named the name that the person provided, the person is authorized to drive the rental car, and that the person has provided their correct address. By way of another example, a wine store may check a state identification to verify that a person is at least twenty-one years of age. In still another example, a grocery store may check a person's driver's license when a person signs up for a rewards program to ensure that the same person does not sign up for multiple rewards program accounts.

### SUMMARY

The present disclosure relates to cryptographically proving identity uniqueness. A verification request may be received. An identity associated with the verification request may be identified. The identity may be verified. In response to the verification request, an NFT may be generated. The NFT may be non-transferrable. The NFT may be stored on a blockchain. The NFT may be associated with a token wallet that is associated with the identity.

In various embodiments, a system for cryptographically proving identity uniqueness includes an identification system electronic device. The identification system electronic device includes a non-transitory storage medium that stores instructions and a processor that executes the instructions to receive a verification request from a verification requesting electronic device; identify an identity associated with the verification request; verify the identity; in response to the verification request, generate a non-fungible token (NFT), the NFT being non-transferrable; store the NFT on a blockchain; and associate the NFT with a token wallet that is associated with the identity.

In some examples, the identification system electronic device identifies the identity by comparing received biometric data with stored biometric data for multiple people that is associated with identity information for the multiple people. In a number of examples, the processor receives an additional verification request, verifies an additional identity associated with the additional verification request, and denies the additional verification request upon determining that an associated additional NFT already exists.

In various examples, the processor receives an updated verification request, revokes the NFT, generates a new NFT, stores the new NFT on the blockchain, and associates the new NFT with an additional token wallet that is associated with the identity. In some examples, the NFT is non-transferable by an owner of the token wallet. In a number of examples, the processor receives a verification reliance request from a verification relying electronic device. In various implementations of such examples, the processor provides information associated with the identity in response to the verification reliance request. In some implementations of such examples, the processor accesses the NFT prior to providing the information. In a number of implementations of such examples, the information includes at least one of an email address, a mailing address, a telephone number, or a name.

In some examples, the processor validates that the identity is associated with a person who attended an event prior to generating the NFT. In a number of examples, the processor verifies the identity by verifying identity information associated with the identity. In various implementations of such examples, the identity information includes at least one of a name, an address, or a telephone number.

In a number of examples, the processor receives an NFT move request, dissociates the NFT from the token wallet, and associates the NFT with an additional token wallet that is associated with the identity. In various implementations of such examples, the processor verifies the identity prior to dissociating the NFT from the token wallet and associating the NFT with the additional token wallet.

In some embodiments, a system for cryptographically proving identity uniqueness includes a verification requesting electronic device. The verification requesting electronic device includes a non-transitory storage medium that stores instructions and a processor that executes the instructions to submit a verification request to an identification system electronic device, the verification request including identity verifying information; receive an indication of a non-fungible token (NFT) that is associated with a token wallet, the token wallet associated with an identity identified using the identity verifying information, the NFT being non-transferrable; and submit a request to perform an action to a verification relying electronic device, the action requiring verification proof, the request to perform the action indicating the NFT.

In various examples, the action includes voting. In some examples, the identity verifying information includes a digital representation of a biometric.

In a number of embodiments, a system for cryptographically proving identity uniqueness includes a verification relying electronic device. The verification relying electronic device includes a non-transitory storage medium that stores instructions and a processor that executes the instructions to receive a request to perform an action from a verification requesting electronic device, the action requiring verification proof; verify that the request to perform the action indicates a generated non-transferrable non-fungible token (NFT) that is associated with a token wallet that is associated with an identified identity of a person who submitted the request; and, upon verifying that the request to perform the action indicates the NFT, perform the action.

In various examples, the action includes a cryptocurrency transfer. In some examples, the action includes obtaining access rights.

### BRIEF DESCRIPTION OF THE DRAWINGS

The disclosure will be readily understood by the following detailed description in conjunction with the accompanying drawings, wherein like reference numerals designate like structural elements.

FIG. 1 depicts an example system for cryptographically proving identity uniqueness.

FIG. 2 is a flow chart illustrating a first example method for cryptographically proving identity uniqueness. The method may be performed by the system of FIG. 1.

FIG. 3 is a flow chart illustrating a second example method for cryptographically proving identity uniqueness. The method may be performed by the system of FIG. 1.

FIG. 4 is a flow chart illustrating a third example method for cryptographically proving identity uniqueness. The method may be performed by the system of FIG. 1.

FIG. 5 is a flow chart illustrating a fourth example method for cryptographically proving identity uniqueness. The method may be performed by the system of FIG. 1.

FIG. 6 is a flow chart illustrating a fifth example method for cryptographically proving identity uniqueness. The method may be performed by the system of FIG. 1.

FIG. 7 is a flow chart illustrating a sixth example method for cryptographically proving identity uniqueness. The method may be performed by the system of FIG. 1.

FIG. 8 is a flow chart illustrating a seventh example method for cryptographically proving identity uniqueness. The method may be performed by the system of FIG. 1.

FIG. 9 is a flow chart illustrating an eighth example method for cryptographically proving identity uniqueness. The method may be performed by the system of FIG. 1.

FIG. 10 is a flow chart illustrating a ninth example method for cryptographically proving identity uniqueness. The method may be performed by the system of FIG. 1.

FIG. 11 is a flow chart illustrating a tenth example method for cryptographically proving identity uniqueness. The method may be performed by the system of FIG. 1.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, apparatuses, methods, and computer program products that embody various elements of the present disclosure. However, it should be understood that the described disclosure may be practiced in a variety of forms in addition to those described herein.

Traditional methods of verifying identity and/or aspects of identity such as verifying physical identification (like driver's licenses, state identification cards, federal identification cards, military identification cards, passports, and so on) become much more challenging when interactions are moved to the technological environment of a computer network. Due to these additional challenges, verifying identity and/or aspects of identity in a computer network environment is a technical problem caused by the technological shift of interactions to the technological environment of a computer network.

Identification systems may collect and/or verify information about identities of people and/or aspects thereof (such as names, ages, addresses, emails, phone numbers, medical information, and so on). These identification systems may be configured to provide one or more attestations to one or more people and/or entities regarding such identities and/or other identity information stored in association with such identities. These identification systems may also be configured to identify people (such as by receiving one or more digital representations of one or more biometrics and comparing such against biometric data stored in association with the identities, receiving logins and passwords and/or other credentials and comparing such against credentials stored in association with the identities, receiving information that only the person corresponding to the identity would know, and so on) and perform one or more actions using identity information associated with the identified identity. Such identification systems may provide a technical solution to the technical problem of the challenges to traditional methods of verifying identity and/or aspects of identity such as verifying physical identification caused by the technological shift of interactions to the technological environment of a computer network.

However, a person or entity may need to be configured to access the identification system in order to obtain one or more attestations regarding the identity and/or identity information of one or more people. Such configuration may be burdensome, require additional hardware and/or software resources, require additional hardware and/or software processing time or resources, not be compatible with existing systems, and so on. The ability to rely on identity verification provided by such identification systems without requiring such configuration would reduce such burdens, allow incompatible systems to be used without modification or replacement, eliminate redundant components, improve the operation of computing systems by reducing required hardware and/or software resources, and so on.

One such technical solution to the above technical problem is for the identification system to generate a non-fungible token (NFT) that corresponds to a request to provide one or more attestations regarding identity of a person and/or one or more aspects thereof. The NFT may be stored on one or more blockchains and associated with one or more token wallets associated with the person. The NFT may be non-transferrable. Then, in order for a person or entity to verify the identity of the person and/or the one or more aspects thereof, the person or entity may verify that the token wallet associated with the person is associated with the NFT.

This allows performance of functions that were previously not performable and enables more efficiency while expending less work, eliminating unnecessary hardware and/or other components, and more efficiently using hardware, software, network, and/or other resources. This may improve the operation of systems involved by reducing unnecessary components, increasing the speed at which the systems perform operations, and/or reducing consumption of hardware, software, network, and/or other resources.

The present disclosure relates to cryptographically proving identity uniqueness. A verification request may be received. An identity associated with the verification request may be identified. The identity may be verified. In response to the verification request, an NFT may be generated. The NFT may be non-transferable. The NFT may be stored on a blockchain. The NFT may be associated with a token wallet that is associated with the identity.

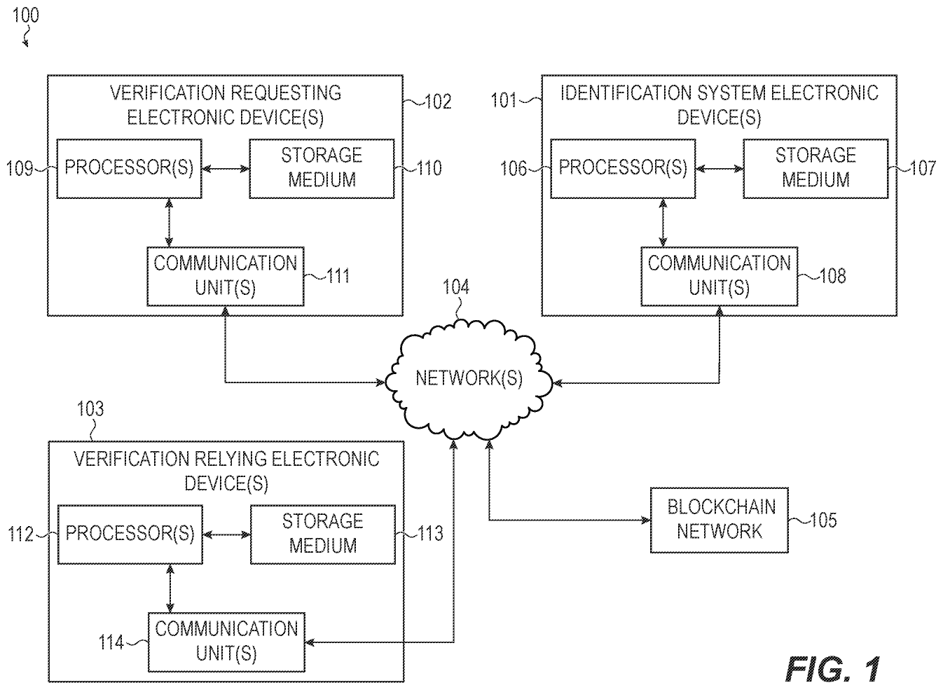

These and other embodiments are discussed below with reference to FIGS. 1-11. However, those skilled in the art will readily appreciate that the detailed description given herein with respect to these Figures is for explanatory purposes only and should not be construed as limiting.

FIG. 1 depicts an example system 100 for cryptographically proving identity uniqueness. The system 100 may include one or more identification system electronic devices 101, verification requesting electronic devices 102, verification relying electronic devices 103, and/or blockchain networks 105 that are operable to communicate with one or more of each other via one or more wired and/or wireless communication networks 104.

However, a person or entity may need to be configured to access the identification system in order to obtain one or more attestations regarding the identity and/or identity information of one or more people. Such configuration may be burdensome, require additional hardware and/or software resources, require additional hardware and/or software processing time or resources, not be compatible with existing systems, and so on. The ability to rely on identity verification provided by such identification systems without requiring such configuration would reduce such burdens, allow incompatible systems to be used without modification or replacement, eliminate redundant components, improve the operation of computing systems by reducing required hardware and/or software resources, and so on.

The system 100 may provide a technical solution to the technical problem of the challenges to traditional methods of verifying identity and/or aspects of identity such as verifying physical identification caused by the technological shift of interactions to the technological environment of a computer network by having the identification system electronic device 101 generate an NFT that corresponds to a request from the verification requesting electronic device 102 to provide one or more attestations regarding the identity of a person and/or one or more aspects thereof. The NFT may be stored on the blockchain network 105 and associated with one or more token wallets associated with the person. The NFT may be non-transferrable. Then, in order for the verification relying electronic device 103 to verify the identity of the person and/or the one or more aspects thereof, the person or entity may verify that the token wallet associated with the person is associated with the NFT.

This allows performance of functions that were previously not performable and enables more efficiency while expending less work, eliminating unnecessary hardware and/or other components, and more efficiently using hardware, software, network, and/or other resources. This may improve the operation of systems involved by reducing unnecessary components, increasing the speed at which the systems perform operations, and/or reducing consumption of hardware, software, network, and/or other resources.

The NFT may be used to verify many different aspects of identity. For example, the NFT may indicate that the identification system electronic device 101 has verified that the identity associated with the token wallet associated with the NFT is a real person. The identification system electronic device 101 may even be configured to provide information regarding that real person in some situations even though that information may not be otherwise ascertainable via the NFT, thus providing anonymity for the identity unless the identification system electronic device 101 is involved to provide the information. This may be used to provide security and/or entitlement for online and/or other transactions. The NFT may also be used to provide proof of reliability for transactions, proof of eligibility for voting, proof that a person is a unique person, proof of age for transactions such as liquor sales, proof of entitlement for transactions such as prescription transactions, proof of event attendance, and so on.

In various implementations, the identification system electronic device 101 may receive a verification request from the verification requesting electronic device 102; identify an identity associated with the verification request; verify the identity; in response to the verification request, generate a non-fungible token (NFT), the NFT being non-transferable; store the NFT on a blockchain; and associate the NFT with a token wallet that is associated with the identity. The identification system electronic device 101 may identify the identity by comparing received biometric data with stored biometric data for multiple people that is associated with identity information for the multiple people.

The identification system electronic device 101 may receive an additional verification request, verify an additional identity associated with the additional verification request, and deny the additional verification request upon determining that an associated additional NFT already exists.

The NFT may be non-transferrable by an owner of the token wallet. In order to change where the NFT is stored, the previous NFT may be revoked and a replacement NFT may be stored at a new location. The identification system electronic device 101 may receive an updated verification request, revoke the NFT, generate a new NFT, store the new NFT on the blockchain, and associate the new NFT with an additional token wallet that is associated with the identity. The identification system electronic device 101 may receive an NFT move request, dissociate the NFT from the token wallet and associate the NFT with an additional token wallet that is associated with the identity. The identification system electronic device 101 may verify the identity prior to dissociating the NFT from the token wallet and associating the NFT with the additional token wallet.

The identification system electronic device 101 may receive a verification reliance request from a verification relying electronic device. The verification reliance request may include a request to provide information. The identification system electronic device 101 may provide information associated with the identity in response to the verification reliance request. The identification system electronic device 101 may access the NFT prior to providing the information. The information may include at least one of an email address, a mailing address, a telephone number, or a name.

The identification system electronic device 101 may validate that the identity is associated with a person who attended an event prior to generating the NFT.

The identification system electronic device 101 may verify the identity by verifying identity information associated with the identity. The identity information includes at least one of a name, an address, or a telephone number.

In some implementations, the verification requesting electronic device 102 may submit a verification request to an identification system electronic device 101, the verification request including identity verifying information; receive an indication of a non-fungible token (NFT) that is associated with a token wallet, the token wallet associated with an identity identified using the identity verifying information, the NFT being non-transferrable; and submit a request to perform an action to a verification relying electronic device, the action requiring verification proof, the request to perform the action indicating the NFT. The action may include voting. The identity verifying information may include a digital representation of a biometric.

In a number of implementations, the verification relying electronic device 103 may receive a request to perform an action from the verification requesting electronic device 102, the action requiring verification proof; verify that the request to perform the action indicates a generated non-transferrable non-fungible token (NFT) that is associated with a token wallet that is associated with an identified identity of a person who submitted the request; and, upon verifying that the request to perform the action indicates the NFT, perform the action. The action may include a cryptocurrency transfer. The action may include obtaining access rights.

The identification system electronic device 101 may store identity information (such as one or more names, addresses, telephone numbers, social security numbers, patient identification numbers or other identifiers, insurance data, financial data, health information (such as one or more temperatures, pupil dilation, medical diagnoses, immunocompromised conditions, medical histories, medical records, infection statuses, vaccinations, immunology data, results of antibody tests evidencing that a person has had a particular communicable illness and recovered, blood test results, saliva test results, and/or the like), and so on) associated with the identities of people (which may be verified identities, where the identities are verified as corresponding to the particular person named and/or where the identity information is verified as valid). Alternatively and/or additionally, some or all of the health information may be stored separately from the identity information but otherwise associated with the identity information, such as in a Health Insurance Portability and Accountability Act (“HIPAA”) compliant or other data store or enclave. Such a data store or enclave may be stored on one or more different storage media than the identity information, or may be stored on the same storage medium or media and logically isolated from the identity information. The health information may be simultaneously and/or substantially simultaneously accessible as the identity information, such as where the identity information includes a health information identifier or key that may be used to access the separately stored health information. The identification system device 101 may control access to the identity information and/or the health information using identification information that is associated with the identity information. The identification information may include biometric data (which may include one or more digital representations of one or more fingerprints, blood vessel scans, palm-vein scans, voiceprints, facial images, retina images, iris images, deoxyribonucleic acid sequences, heart rhythms, gaits, and so on), one or more logins and/or passwords, authorization tokens, social media and/or other accounts, and so on. In various implementations, the identification system electronic device 101 may allow the person associated with an identity to control access to the identity information, the health information, and/or other information (such as payment account information, health information (such as medical records, HIPAA protected information in order to be compliant with various legal restrictions, and so on), contact information, and so on. The identification system device may control access to such information according to input received from the person. The identification system electronic device 101 may be operable to communicate with a station in order to handle requests to provide the identity information and/or the health information, update and/or otherwise add to the identity information and/or the health information, provide attestations regarding and/or related to the identity information and/or the health information (such as whether or not a person is of a particular age, whether or not a person has a particular license or insurance policy, whether or not a person has been monitored as having particular health information, whether or not a person has had a particular vaccination, whether or not an antibody test evidences that a person has had a particular communicable illness and recovered, whether or not a person has a particular ticket or authorization, whether or not a person has been monitored as having particular antibodies, whether or not a person has been assigned a particular medical diagnosis, and so on), evaluate health information stored in the identity information and/or otherwise associated with the identity information and/or other information stored in the identity information, perform transactions, allow or deny access, route one or more persons, and/or perform one or more other actions.

The identification system electronic device 101 may be any kind of electronic device and/or cloud and/or other computing arrangement. Examples of such devices include, but are not limited to, one or more desktop computing devices, laptop computing devices, mobile computing devices, wearable devices, tablet computing devices, mobile telephones, kiosks and/or other stations, smart phones, printers, displays, vehicles, kitchen appliances, entertainment system devices, digital media players, and so on. The identification system electronic device 101 may include one or more processors 106 and/or other processing units or controllers, communication units 108 (such as one or more network adapters and/or other devices used by a device to communicate with one or more other devices), non-transitory storage media 107, and/or other components. The processor 106 may execute one or more sets of instructions stored in the non-transitory storage media 107 to perform various functions, such as receiving and/or storing biometric data and/or other identification information, receiving and/or storing identity information and/or health information, matching one or more received digital representations of biometrics and/or other identification information to stored data, retrieving identity information and/or health information associated with stored data matching one or more received digital representations of biometrics and/or other identification information, providing retrieved identity information and/or health information, communicating (such as with one or more of the verification requesting electronic device 102, the verification relying electronic device 103, the blockchain network 105, and so on) via the network 104 using the communication unit 108, and so on. Alternatively and/or additionally, the identification system device 101 may involve one or more memory allocations configured to store at least one executable asset and one or more processor allocations configured to access the one or more memory allocations and execute the at least one executable asset to instantiate one or more processes and/or services, such as one or more gallery management services, biometric identifications services, and so on.

Similarly, the verification requesting electronic device 102 may be any kind of device. The electronic device may include one or more processors 109 and/or other processing units and/or controllers, one or more non-transitory storage media 110 (which may take the form of, but is not limited to, a magnetic storage medium; optical storage medium; magneto-optical storage medium; read only memory; random access memory; erasable programmable memory; flash memory; and so on), one or more communication units 111, one or more health sensors (such as a thermometer and/or other thermal sensor, a blood pressure sensor, a blood test sensor, a blood vessel scanner, a palm-vein scanner, a still image and/or video camera, a 2D and/or 3D image sensor, a saliva sensor, a breath sensor, a deoxyribonucleic acid sensor, a heart rhythm monitor, a microphone, sweat sensors, and so on), one or more biometric readers (such as a fingerprint scanner, a blood vessel scanner, a palm-vein scanner, an optical fingerprint scanner, a phosphorescent fingerprint scanner, a still image and/or video camera, a 2D and/or 3D image sensor, a capacitive sensor, a saliva sensor, a deoxyribonucleic acid sensor, a heart rhythm monitor, a microphone, and so on), and/or one or more other components. The processor 109 may execute one or more sets of instructions stored in the non-transitory storage media 110 to perform various functions, such as using the biometric reader to obtain one or more digital representations of one or more biometrics (such as a digital representation of a fingerprint, a blood vessel scan, a palm-vein scan, a voiceprint, a facial image, a retina image, an iris image, a deoxyribonucleic acid sequence, a heart rhythm, a gait, and so on) for a person, obtaining health information for a person using the health sensor, communicating with the identification system device 101 via the network 104 using the communication unit 111, and so on.

Likewise, the verification relying electronic device 103 may be any kind of device. The electronic device may include one or more processors 112 and/or other processing units and/or controllers, one or more non-transitory storage media 113 (which may take the form of, but is not limited to, a magnetic storage medium; optical storage medium; magneto-optical storage medium; read only memory; random access memory; erasable programmable memory; flash memory; and so on), one or more communication units 114, and/or one or more other components. The processor 112 may execute one or more sets of instructions stored in the non-transitory storage media 113 to perform various functions, such as communicating with the identification system device 101 via the network 104 using the communication unit 114, communicating with the verification requesting electronic device 102 via the network 104 using the communication unit 114, and so on.

As used herein, the term “computing resource” (along with other similar terms and phrases, including, but not limited to, “computing device” and “computing network”) refers to any physical and/or virtual electronic device or machine component, or set or group of interconnected and/or communicably coupled physical and/or virtual electronic devices or machine components, suitable to execute or cause to be executed one or more arithmetic or logical operations on digital data.

Example computing resources contemplated herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices and systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

Example information can include, but may not be limited to: personal identification information (e.g., names, social security numbers, telephone numbers, email addresses, physical addresses, driver's license information, passport numbers, and so on); identity documents (e.g., driver's licenses, passports, government identification cards or credentials, and so on); protected health information (e.g., medical records, dental records, and so on); financial, banking, credit, or debt information; third-party service account information (e.g., usernames, passwords, social media handles, and so on); encrypted or unencrypted files; database files; network connection logs; shell history; filesystem files; libraries, frameworks, and binaries; registry entries; settings files; executing processes; hardware vendors, versions, and/or information associated with the compromised computing resource; installed applications or services; password hashes; idle time, uptime, and/or last login time; document files; product renderings; presentation files; image files; customer information; configuration files; passwords; and so on. It may be appreciated that the foregoing examples are not exhaustive.

The foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

Although the system 100 is illustrated and described as including particular components arranged in a particular configuration, it is understood that this is an example. In various implementations, various configurations of the same, similar, and/or different components may be used without departing from the scope of the present disclosure.

For example, the system 100 is shown as including the verification requesting electronic device 102, the verification relying electronic device 103, and the identification system electronic device 101. However, it is understood that this is an example. In various implementations, one or more of these may be omitted. Various configurations are possible and contemplated without departing from the scope of the present disclosure.

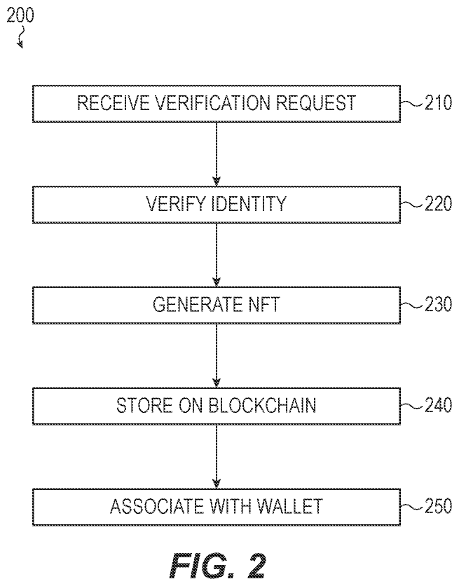

FIG. 2 is a flow chart illustrating a first example method 200 for cryptographically proving identity uniqueness. The method 200 may be performed by the system 100 of FIG. 1.

At operation 210, an electronic device (such as the identification system electronic device 101, the verification requesting electronic device 102, and/or the verification relying electronic device 103 of FIG. 1) may receive a verification request. The verification request may include a request to provide an attestation regarding verification of an identity and/or an aspect thereof.

At operation 220, the electronic device may verify the identity. This may include collecting and/or storing identity information, verifying that the identity information is accurate, verifying that a person is who they assert, and so on.

At operation 230, the electronic device may generate one or more NFTs. At operation 240, the electronic device may store the NFT on one or more blockchains. At operation 250, the electronic device may associate with a wallet. The wallet may be a token wallet that is associated with the identity.

In various examples, this example method 200 may be implemented using a group of interrelated software modules or components that perform various functions discussed herein. These software modules or components may be executed within a cloud network and/or by one or more computing devices, such as the identification system electronic device 101, the verification requesting electronic device 102, and/or the verification relying electronic device 103 of FIG. 1.

Although the example method 200 is illustrated and described as including particular operations performed in a particular order, it is understood that this is an example. In various implementations, various orders of the same, similar, and/or different operations may be performed without departing from the scope of the present disclosure.

For example, the method 200 is illustrated and described as verifying the identity after receiving the verification request. However, it is understood that this is an example. In some implementations, the electronic device may have previously verified the identity and may verify that the request comes from the person associated with the identity upon receiving the verification request. Various configurations are possible and contemplated without departing from the scope of the present disclosure.

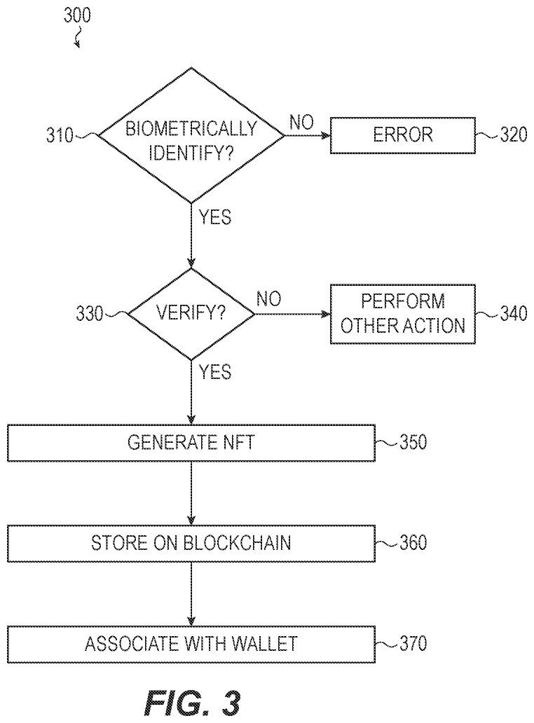

FIG. 3 is a flow chart illustrating a second example method 300 for cryptographically proving identity uniqueness. The method 300 may be performed by the system 100 of FIG. 1.

At operation 310, an electronic device (such as the identification system electronic device 101, the verification requesting electronic device 102, and/or the verification relying electronic device 103 of FIG. 1) may determine whether or not a requestor can be biometrically identified. If not, the flow may proceed to operation 320 where the electronic device may determine that an error has occurred. Otherwise, the flow may proceed to operation 330.

At operation 330, the electronic device may determine whether or not an identity associated with the requestor is verified. If not, the flow may proceed to operation 340 where the electronic device performs an action other than generating an NFT (which may include verifying the identity). Otherwise, the flow may proceed to operation 350.

At operation 350, the electronic device may generate one or more NFTs. At operation 360, the electronic device may store the NFT on one or more blockchains. At operation 370, the electronic device may associate the NFT with one or more token wallets associated with the identity.

In various examples, this example method 300 may be implemented using a group of interrelated software modules or components that perform various functions discussed herein. These software modules or components may be executed within a cloud network and/or by one or more computing devices, such as the identification system electronic device 101, the verification requesting electronic device 102, and/or the verification relying electronic device 103 of FIG. 1.

Although the example method 300 is illustrated and described as including particular operations performed in a particular order, it is understood that this is an example. In various implementations, various orders of the same, similar, and/or different operations may be performed without departing from the scope of the present disclosure.

For example, if implementations where the other action performed at operation 340 includes verifying the identity, the flow may then proceed to operation 350 and/or return to operation 330 where the electronic device may again determine whether or not the identity is verified. Various configurations are possible and contemplated without departing from the scope of the present disclosure.

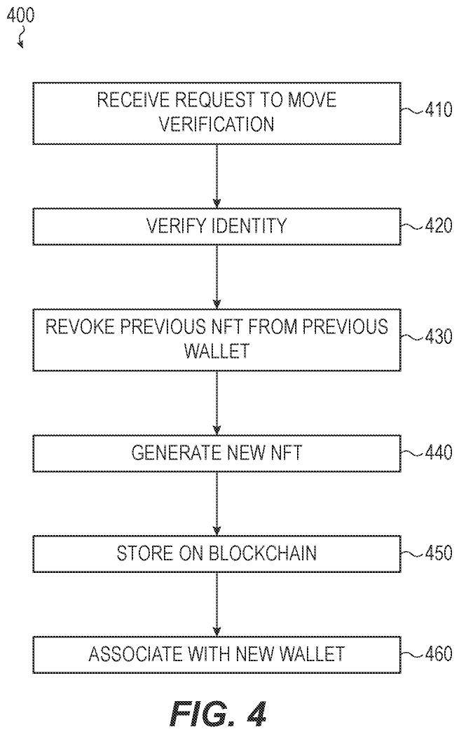

FIG. 4 is a flow chart illustrating a third example method 400 for cryptographically proving identity uniqueness. The method 400 may be performed by the system 100 of FIG. 1.

At operation 410, an electronic device (such as the identification system electronic device 101, the verification requesting electronic device 102, and/or the verification relying electronic device 103 of FIG. 1) may receive a request to move a verification. At operation 420, the electronic device may verify the identity of the requestor.

At operation 430, the electronic device may revoke the previous NFT from the previous wallet with which the previous NFT is associated. At operation 440, the electronic device may generate a new NFT. At operation 450, the electronic device may store the new NFT on one or more blockchains. At operation 460, the electronic device may associate the new NFT with a new token wallet.

In various examples, this example method 400 may be implemented using a group of interrelated software modules or components that perform various functions discussed herein. These software modules or components may be executed within a cloud network and/or by one or more computing devices, such as the identification system electronic device 101, the verification requesting electronic device 102, and/or the verification relying electronic device 103 of FIG. 1.

Although the example method 400 is illustrated and described as including particular operations performed in a particular order, it is understood that this is an example. In various implementations, various orders of the same, similar, and/or different operations may be performed without departing from the scope of the present disclosure.

For example, the method is illustrated and described as moving the NFT on request. However, in some situations, the electronic device may verify that the requestor is the same person as the one for whom the NFT was generated prior to revoking the previous NFT and generating the new NFT. Various configurations are possible and contemplated without departing from the scope of the present disclosure.

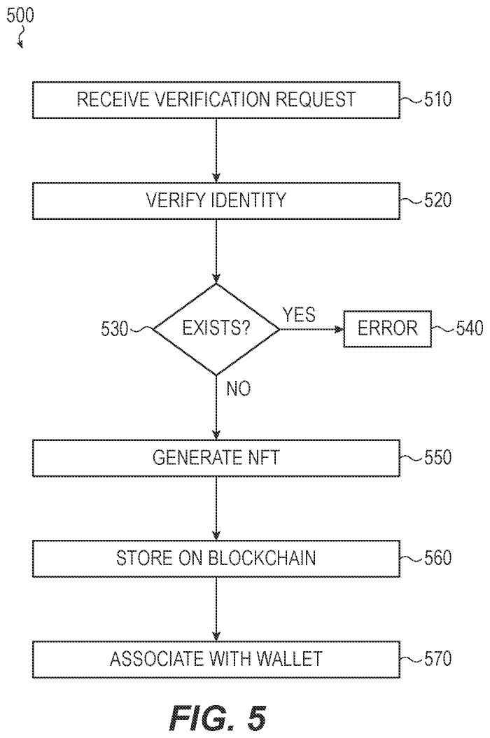

FIG. 5 is a flow chart illustrating a fourth example method 500 for cryptographically proving identity uniqueness. The method 500 may be performed by the system 100 of FIG. 1.

At operation 510, an electronic device (such as the identification system electronic device 101, the verification requesting electronic device 102, and/or the verification relying electronic device 103 of FIG. 1) may receive a verification request. At operation 520, the electronic device may verify the identity associated with the verification request.

At operation 530, the electronic device may determine whether or not an NFT associated with the verification request already exists. The electronic device may not permit multiple NFTs associated with the verification request to be generated. For example, the NFT may be an indicator that the requestor is a unique person. Multiple NFTs for such a purpose would contradict the indication that the requestor is a unique person. If so, the flow may proceed to operation 540 where the electronic device may determine that an error has occurred. Otherwise, the flow may proceed to operation 550.

At operation 550, the electronic device may generate an NFT. At operation 560, the electronic device may store on the NFT on one or more blockchains. At operation 570, the electronic device may associate the NFT with a token wallet.

In various examples, this example method 500 may be implemented using a group of interrelated software modules or components that perform various functions discussed herein. These software modules or components may be executed within a cloud network and/or by one or more computing devices, such as the identification system electronic device 101, the verification requesting electronic device 102, and/or the verification relying electronic device 103 of FIG. 1.

Although the example method 500 is illustrated and described as including particular operations performed in a particular order, it is understood that this is an example. In various implementations, various orders of the same, similar, and/or different operations may be performed without departing from the scope of the present disclosure.

For example, the method is illustrated and described as verifying the identity. However, it is understood that this is an example. In some implementations, such an operation may be omitted.

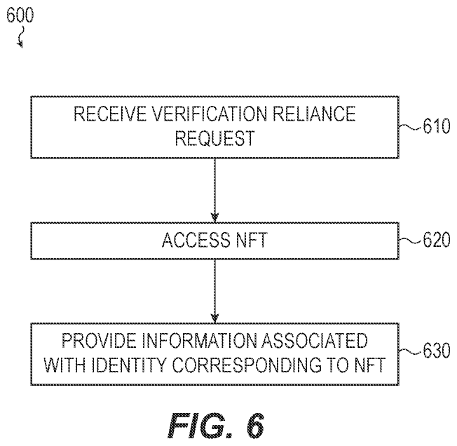

FIG. 6 is a flow chart illustrating a fifth example method 600 for cryptographically proving identity uniqueness. The method 600 may be performed by the system 100 of FIG. 1.

At operation 610, an electronic device (such as the identification system electronic device 101, the verification requesting electronic device 102, and/or the verification relying electronic device 103 of FIG. 1) may receive a verification reliance request. The verification reliance request may request identity information regarding the identity for which an NFT was generated.

At operation 620, the electronic device may access the NFT. The NFT may be associated with a token wallet associated with the identity.

At operation 630, the electronic device may provide information associated with the identity corresponding to the NFT. In some examples, the electronic device may determine whether or not the information is authorized to be provided prior to providing such, such as whether or not a person associated with the identity agreed to have such information provided. Various configurations are possible and contemplated without departing from the scope of the present disclosure.

In various examples, this example method 600 may be implemented using a group of interrelated software modules or components that perform various functions discussed herein. These software modules or components may be executed within a cloud network and/or by one or more computing devices, such as the identification system electronic device 101, the verification requesting electronic device 102, and/or the verification relying electronic device 103 of FIG. 1.

Although the example method 600 is illustrated and described as including particular operations performed in a particular order, it is understood that this is an example. In various implementations, various orders of the same, similar, and/or different operations may be performed without departing from the scope of the present disclosure.

For example, the method 600 is illustrated and described as accessing the NFT. However, it is understood that this is an example. In some implementations, the electronic device may use transactional data recorded when the NFT was generated in order to determine the identity for which to obtain information without accessing the NFT. Various configurations are possible and contemplated without departing from the scope of the present disclosure.

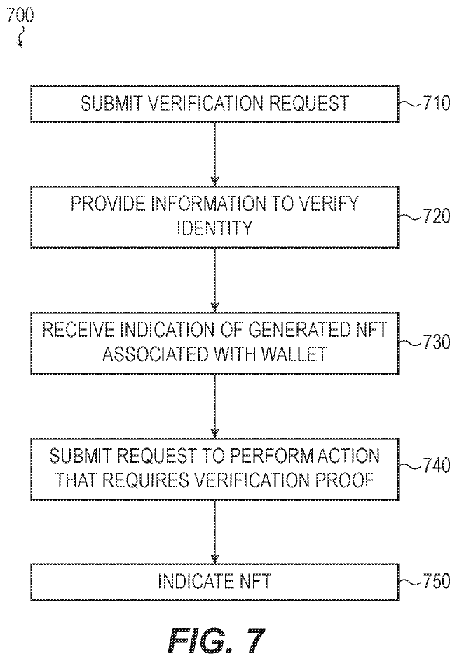

FIG. 7 is a flow chart illustrating a sixth example method 700 for cryptographically proving identity uniqueness. The method 700 may be performed by the system 100 of FIG. 1.

At operation 710, an electronic device (such as the identification system electronic device 101, the verification requesting electronic device 102, and/or the verification relying electronic device 103 of FIG. 1) may submit a verification request. The verification request may specify what exactly is to be verified. At operation 720, the electronic device may provide information that may be used to verify the identity of the requestor. For example, the information may include one or more names, phone numbers, addresses, emails, and so on. At operation 730, the electronic device may receive an indication of a generated NFT associated with a token wallet that is associated with the identity.

At operation 740, the electronic device may submit a request to perform an action that requires verification proof. For example, the action may include voting, purchasing alcohol, trading cryptocurrency, and so on.

At operation 750, the electronic device may indicate the NFT as part of providing the verification proof. The indication may indicate the token wallet associated with the NFT.

In various examples, this example method 700 may be implemented using a group of interrelated software modules or components that perform various functions discussed herein. These software modules or components may be executed within a cloud network and/or by one or more computing devices, such as the identification system electronic device 101, the verification requesting electronic device 102, and/or the verification relying electronic device 103 of FIG. 1.

Although the example method 700 is illustrated and described as including particular operations performed in a particular order, it is understood that this is an example. In various implementations, various orders of the same, similar, and/or different operations may be performed without departing from the scope of the present disclosure.

For example, the method 700 illustrates and describes operations 710-730 and 740-750 being performed by the same electronic device. However, it is understood that this is an example. In various implementations, such operations may be performed by one or more different electronic devices. Various configurations are possible and contemplated without departing from the scope of the present disclosure.

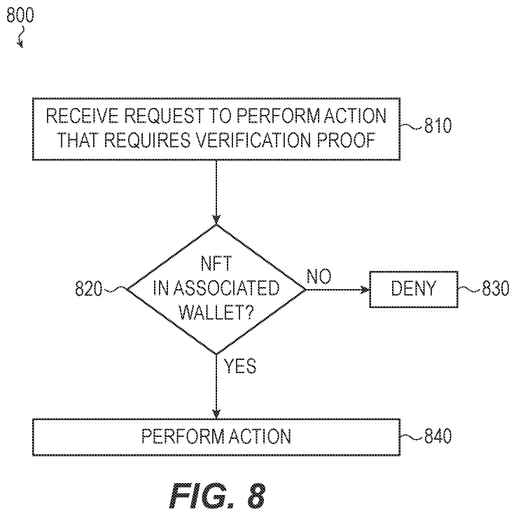

FIG. 8 is a flow chart illustrating a seventh example method 800 for cryptographically proving identity uniqueness. The method 800 may be performed by the system 100 of FIG. 1.

At operation 810, an electronic device (such as the identification system electronic device 101, the verification requesting electronic device 102, and/or the verification relying electronic device 103 of FIG. 1) may receive a request to perform one or more actions that require verification proof. For example, the action may include voting, purchasing alcohol, trading cryptocurrency, and so on.

At operation 820, the electronic device may determine whether or there an NFT in an associated token wallet that corresponds to the verification proof. If not, the flow may proceed to operation 830 where the electronic device may deny performance of the action. Otherwise, the flow may proceed to operation 840 where the electronic device may perform the action.

In various examples, this example method 800 may be implemented using a group of interrelated software modules or components that perform various functions discussed herein. These software modules or components may be executed within a cloud network and/or by one or more computing devices, such as the identification system electronic device 101, the verification requesting electronic device 102, and/or the verification relying electronic device 103 of FIG. 1.

Although the example method 800 is illustrated and described as including particular operations performed in a particular order, it is understood that this is an example. In various implementations, various orders of the same, similar, and/or different operations may be performed without departing from the scope of the present disclosure.

For example, in some implementations, the method 800 may include one or more additional operations. Such additional operations may include receiving an indication of a location of the NFT. Various configurations are possible and contemplated without departing from the scope of the present disclosure.

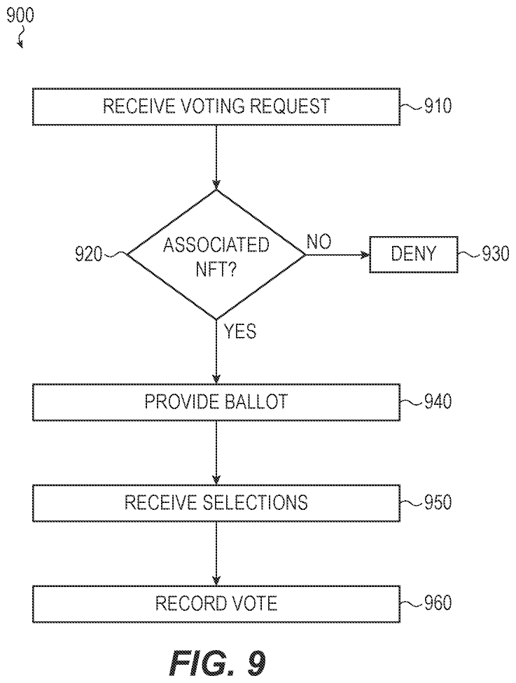

FIG. 9 is a flow chart illustrating an eighth example method 900 for cryptographically proving identity uniqueness. The method 900 may be performed by the system 100 of FIG. 1.

At operation 910, an electronic device (such as the identification system electronic device 101, the verification requesting electronic device 102, and/or the verification relying electronic device 103 of FIG. 1) may receive a voting request. The voting request may be a request to vote in a municipal, state, federal, and/or other election.

At operation 920, the electronic device may determine whether or not there is an associated NFT corresponding to the voting request. Such an NFT may indicate that the requestor is authorized to vote. If not the flow may proceed to operation 930 where the electronic device may deny the voting request. Otherwise the flow may proceed to operation 940.

At operation 940, the electronic device may provide a ballot corresponding to the voting request. At operation 950, the electronic device may receive one or more selections corresponding to the ballot. At operation 960, the electronic device may record a vote corresponding to the one or more selections.

In various examples, this example method 900 may be implemented using a group of interrelated software modules or components that perform various functions discussed herein. These software modules or components may be executed within a cloud network and/or by one or more computing devices, such as the identification system electronic device 101, the verification requesting electronic device 102, and/or the verification relying electronic device 103 of FIG. 1.

Although the example method 900 is illustrated and described as including particular operations performed in a particular order, it is understood that this is an example. In various implementations, various orders of the same, similar, and/or different operations may be performed without departing from the scope of the present disclosure.

For example, the method 900 is illustrated and described as providing the ballot after determining authorization to vote. However, it is understood that this is an example. In various implementations, such operations may be reversed. Various configurations are possible and contemplated without departing from the scope of the present disclosure.

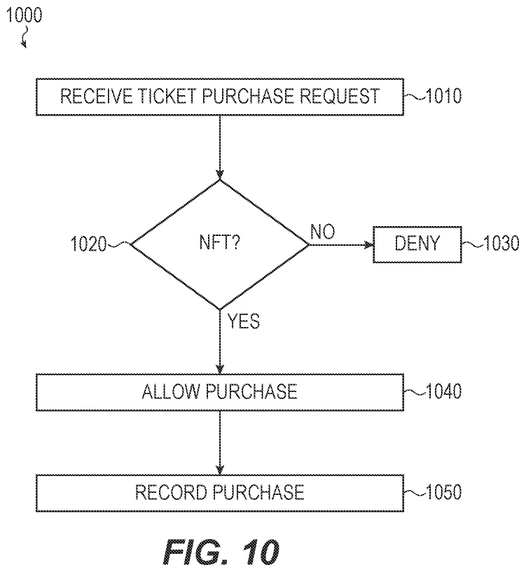

FIG. 10 is a flow chart illustrating a ninth example method 1000 for cryptographically proving identity uniqueness. The method 1000 may be performed by the system 100 of FIG. 1.

At operation 1010, an electronic device (such as the identification system electronic device 101, the verification requesting electronic device 102, and/or the verification relying electronic device 103 of FIG. 1) may receive a ticket purchase request. The ticket purchase request may correspond to tickets that require verification proof that the requestor is a unique person, lives in a particular location, and so on.

At operation 1020, the electronic device may determine whether or not there is an associated NFT corresponding to the ticket purchase request. Such an NFT may be associated with a token wallet associated with the requestor. If not the flow may proceed to operation 1030 where the electronic device may deny the ticket purchase request. Otherwise the flow may proceed to operation 1040.

At operation 1040, the electronic device may allow a purchase corresponding to the ticket purchase request. At operation 1050, the electronic device may record the purchase.

In various examples, this example method 1000 may be implemented using a group of interrelated software modules or components that perform various functions discussed herein. These software modules or components may be executed within a cloud network and/or by one or more computing devices, such as the identification system electronic device 101, the verification requesting electronic device 102, and/or the verification relying electronic device 103 of FIG. 1.

Although the example method 1000 is illustrated and described as including particular operations performed in a particular order, it is understood that this is an example. In various implementations, various orders of the same, similar, and/or different operations may be performed without departing from the scope of the present disclosure.

For example, the method 1000 is illustrated and described as recoding the purchase. However, in some implementations, such an operation may be performed by another device and such an operation may be omitted from the method 1000. Various configurations are possible and contemplated without departing from the scope of the present disclosure.

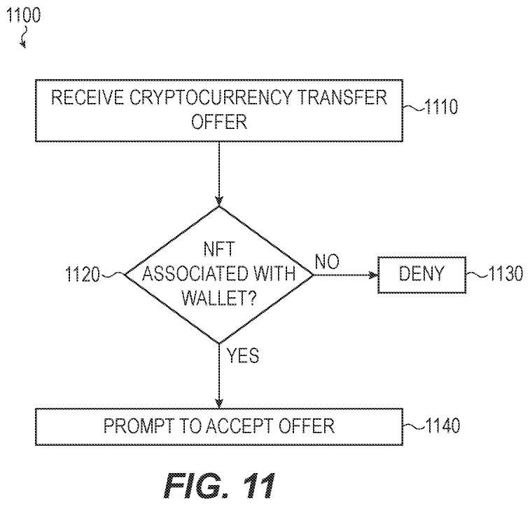

FIG. 11 is a flow chart illustrating a tenth example method 1100 for cryptographically proving identity uniqueness. The method 1100 may be performed by the system 100 of FIG. 1.

At operation 1110, an electronic device (such as the identification system electronic device 101, the verification requesting electronic device 102, and/or the verification relying electronic device 103 of FIG. 1) may receive a cryptocurrency transfer offer.

At operation 1120, the electronic device may determine whether or not there is an associated NFT corresponding to the cryptocurrency transfer offer. Such an NFT may be associated with a token wallet associated with the offeror and may indicate that the offeror is verified with an identification service. If not the flow may proceed to operation 1130 where the electronic device may deny the cryptocurrency transfer offer. Otherwise the flow may proceed to operation 1140 where the electronic device may prompt a user to accept the cryptocurrency transfer offer.

In various examples, this example method 1100 may be implemented using a group of interrelated software modules or components that perform various functions discussed herein. These software modules or components may be executed within a cloud network and/or by one or more computing devices, such as the identification system electronic device 101, the verification requesting electronic device 102, and/or the verification relying electronic device 103 of FIG. 1.

Although the example method 1100 is illustrated and described as including particular operations performed in a particular order, it is understood that this is an example. In various implementations, various orders of the same, similar, and/or different operations may be performed without departing from the scope of the present disclosure.

For example, the method 1100 is illustrated and described as promoting to accept the cryptocurrency transfer offer. In some implementations, the method 1100 may further include accepting the cryptocurrency transfer offer in response to input from the user. Various configurations are possible and contemplated without departing from the scope of the present disclosure.

In various implementations, a system for cryptographically proving identity uniqueness may include an identification system electronic device. The identification system electronic device may include a non-transitory storage medium that stores instructions and a processor that executes the instructions to receive a verification request from a verification requesting electronic device; identify an identity associated with the verification request; verify the identity; in response to the verification request, generate an NFT, the NFT being non-transferrable; store the NFT on a blockchain; and associate the NFT with a token wallet that is associated with the identity.

In some examples, the identification system electronic device may identify the identity by comparing received biometric data with stored biometric data for multiple people that is associated with identity information for the multiple people. In a number of examples, the processor may receive an additional verification request, verify an additional identity associated with the additional verification request, and deny the additional verification request upon determining that an associated additional NFT already exists.

In various examples, the processor may receive an updated verification request, revoke the NFT, generate a new NFT, store the new NFT on the blockchain, and associate the new NFT with an additional token wallet that is associated with the identity. In some examples, the NFT may be non-transferrable by an owner of the token wallet. In a number of examples, the processor may receive a verification reliance request from a verification relying electronic device. In various such examples, the processor may provide information associated with the identity in response to the verification reliance request. In some such examples, the processor may access the NFT prior to providing the information. In a number of such examples, the information may include at least one of an email address, a mailing address, a telephone number, or a name.

In some examples, the processor may validate that the identity is associated with a person who attended an event prior to generating the NFT. In a number of examples, the processor may verify the identity by verifying identity information associated with the identity. In various such examples, the identity information may include at least one of a name, an address, or a telephone number.

In a number of examples, the processor may receive an NFT move request, dissociate the NFT from the token wallet, and associate the NFT with an additional token wallet that is associated with the identity. In various such examples, the processor may verify the identity prior to dissociating the NFT from the token wallet and associating the NFT with the additional token wallet.

In some implementations, a system for cryptographically proving identity uniqueness may include a verification requesting electronic device. The verification requesting electronic device may include a non-transitory storage medium that stores instructions and a processor that executes the instructions to submit a verification request to an identification system electronic device, the verification request including identity verifying information; receive an indication of a NFT that is associated with a token wallet, the token wallet associated with an identity identified using the identity verifying information, the NFT being non-transferrable; and submit a request to perform an action to a verification relying electronic device, the action requiring verification proof, the request to perform the action indicating the NFT.

In various examples, the action may include voting. In some examples, the identity verifying information may include a digital representation of a biometric.

In a number of embodiments, a system for cryptographically proving identity uniqueness may include a verification relying electronic device. The verification relying electronic device may include a non-transitory storage medium that stores instructions and a processor that executes the instructions to receive a request to perform an action from a verification requesting electronic device, the action requiring verification proof; verify that the request to perform the action indicates a generated non-transferrable NFT that is associated with a token wallet that is associated with an identified identity of a person who submitted the request; and, upon verifying that the request to perform the action indicates the NFT, perform the action.

In various examples, the action may include a cryptocurrency transfer. In some examples, the action may include obtaining access rights.

Although the above illustrates and describes a number of embodiments, it is understood that these are examples. In various implementations, various techniques of individual embodiments may be combined without departing from the scope of the present disclosure.

As described above and illustrated in the accompanying figures, the present disclosure relates to cryptographically proving identity uniqueness. A verification request may be received. An identity associated with the verification request may be identified. The identity may be verified. In response to the verification request, an NFT may be generated. The NFT may be non-transferrable. The NFT may be stored on a blockchain. The NFT may be associated with a token wallet that is associated with the identity.

The present disclosure recognizes that biometric and/or other personal data is owned by the person from whom such biometric and/or other personal data is derived. This data can be used to the benefit of those people. For example, biometric data may be used to conveniently and reliably identify and/or authenticate the identity of people, access securely stored financial and/or other information associated with the biometric data, and so on. This may allow people to avoid repeatedly providing physical identification and/or other information.

The present disclosure further recognizes that the entities who collect, analyze, store, and/or otherwise use such biometric and/or other personal data should comply with well-established privacy policies and/or privacy practices. Particularly, such entities should implement and consistently use privacy policies and practices that are generally recognized as meeting or exceeding industry or governmental requirements for maintaining security and privately maintaining biometric and/or other personal data, including the use of encryption and security methods that meets or exceeds industry or government standards. For example, biometric and/or other personal data should be collected for legitimate and reasonable uses and not shared or sold outside of those legitimate uses. Further, such collection should occur only after receiving the informed consent. Additionally, such entities should take any needed steps for safeguarding and securing access to such biometric and/or other personal data and ensuring that others with access to the biometric and/or other personal data adhere to the same privacy policies and practices. Further, such entities should certify their adherence to widely accepted privacy policies and practices by subjecting themselves to appropriate third party evaluation.

Additionally, the present disclosure recognizes that people may block the use of, storage of, and/or access to biometric and/or other personal data. Entities who typically collect, analyze, store, and/or otherwise use such biometric and/or other personal data should implement and consistently prevent any collection, analysis, storage, and/or other use of any biometric and/or other personal data blocked by the person from whom such biometric and/or other personal data is derived.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A system for cryptographically proving identity uniqueness, comprising:
an identification system electronic device, comprising:
a non-transitory storage medium that stores instructions; and
a processor that executes the instructions to:
receive a verification request from a verification requesting electronic device;
identify an identity associated with the verification request;
verify the identity;
in response to the verification request, generate a non-fungible token (NFT), the NFT being non-transferrable;
store the NFT on a blockchain; and
associate the NFT with a token wallet that is associated with the identity.

2. The system of claim 1, wherein the identification system electronic device identifies the identity by comparing received biometric data with stored biometric data for multiple people that is associated with identity information for the multiple people.

3. The system of claim 1, wherein the processor:
receives an additional verification request;
verifies an additional identity associated with the additional verification request; and
denies the additional verification request upon determining that an associated additional NFT already exists.

4. The system of claim 1, wherein the processor:
receives an updated verification request;
revokes the NFT;
generates a new NFT;
stores the new NFT on the blockchain; and
associates the new NFT with an additional token wallet that is associated with the identity.

5. The system of claim 1, wherein the NFT is non-transferrable by an owner of the token wallet.

6. The system of claim 1, wherein the processor receives a verification reliance request from a verification relying electronic device.

7. The system of claim 6, wherein the processor provides information associated with the identity in response to the verification reliance request.

8. The system of claim 7, wherein the processor accesses the NFT prior to providing the information.

9. The system of claim 8, wherein the information comprises at least one of an email address, a mailing address, a telephone number, or a name.

10. The system of claim 1, wherein the processor validates that the identity is associated with a person who attended an event prior to generating the NFT.

11. The system of claim 1, wherein the processor verifies the identity by verifying identity information associated with the identity.

12. The system of claim 11, wherein the identity information includes at least one of a name, an address, or a telephone number.

13. The system of claim 1, wherein the processor:
receives an NFT move request;
dissociates the NFT from the token wallet; and
associates the NFT with an additional token wallet that is associated with the identity.

14. The system of claim 13, wherein the processor verifies the identity prior to dissociating the NFT from the token wallet and associating the NFT with the additional token wallet.

15. A system for cryptographically proving identity uniqueness, comprising:
a verification requesting electronic device, comprising:
a non-transitory storage medium that stores instructions; and
a processor that executes the instructions to:
submit a verification request to an identification system electronic device, the verification request including identity verifying information;
receive an indication of a non-fungible token (NFT) that is associated with a token wallet, the token wallet associated with an identity identified using the identity verifying information, the NFT being non-transferrable; and
submit a request to perform an action to a verification relying electronic device, the action requiring verification proof, the request to perform the action indicating the NFT.

16. The system of claim 15, wherein the action comprises voting.

17. The system of claim 15, wherein the identity verifying information includes a digital representation of a biometric.

18. A system for cryptographically proving identity uniqueness, comprising:
a verification relying electronic device, comprising:
a non-transitory storage medium that stores instructions; and
a processor that executes the instructions to:
receive a request to perform an action from a verification requesting electronic device, the action requiring verification proof;
verify that the request to perform the action indicates a generated non-transferrable non-fungible token (NFT) that is associated with a token wallet that is associated with an identified identity of a person who submitted the request; and
upon verifying that the request to perform the action indicates the NFT, perform the action.

19. The system of claim 18, wherein the action comprises a cryptocurrency transfer.

20. The system of claim 18, wherein the action comprises obtaining access rights.
